(19) United States
(12) Patent Application Publication
(10) Pub. No.: US 2010/0241864 A1
(43) Pub. Date: Sep. 23, 2010

(54) AUTHENTICATING AN INTEGRATED CIRCUIT BASED ON STORED INFORMATION

(75) Inventors: Jim KELLEY, Boston, MA (US); Per K. ENGE, Mountain View, CA (US); Peter L. LEVIN, Silver Spring, MD (US); Sherman C. LO, San Mateo, CA (US); David S. DE LORENZO, Palo Alto, CA (US)

Correspondence Address: LAHIVE & COCKFIELD, LLP;FLOOR 30, SUITE 3000, ONE POST OFFICE SQUARE, BOSTON, MA, 02109, US

(73) Assignee: DAFCA, INC., Framingham, MA (US)

(21) Appl. No.: 12/623,216

(22) Filed: Nov. 20, 2009

Related U.S. Application Data
(60) Provisional application No. 61/199,864, filed on Nov. 21, 2008.

(51) Int. Cl. H04L 9/32; G01S 19/42

(52) U.S. Cl. 713/179; 342/357.25

(57) ABSTRACT

Exemplary embodiments provide methods and systems of authenticating an integrated circuit (IC). The manufacturing location of an IC is authenticated by storing in the IC a local signature derived from a GPS signal that was received at the manufacturing location at the time of manufacture. A remote signature is derived from a GPS signal that was received at a remote site nearly simultaneously as the reception of the GPS signal at the manufacturing location. The local signature is compared to the remote signature at an authentication site to determine the authenticity of the IC.

### RELATED APPLICATIONS

This application claims priority to provisional U.S. patent application no. 61/199,864 filed Nov. 21, 2008. This application is also related to and claims the benefit of U.S. patent application Ser. No. 12/012,327 filed Feb. 8, 2008. The entire contents of each of the aforementioned applications are hereby incorporated herein by reference.

### BACKGROUND OF THE INVENTION

Exemplary embodiments of the present invention relate to global positioning and, more particularly, to authenticating global positioning information provided by integrated circuits. In the context of the present invention, global positioning encompasses the absolute geo-location of an object, as well as the relative location of one object relative to another object.

Global positioning may be provided by various electronic methods. Some of these methods are terrestrial, while some others are based on satellites. A satellite system currently in common use is the Global Positioning System (GPS). Many people have GPS receivers that assist them in determining their physical location. GPS uses a collection of satellites that are arranged to orbit the Earth so that at least four satellites are always within the reception range of a receiver at any point on the globe.

One of the signals that the GPS satellites transmit is a signal at frequency L1, which is used as a carrier to modulate a data signal that is itself modulated with a Code Division Multiple Access (CDMA) code, commonly referred to as the C/A code. The CDMA code that is used by each satellite is unique to the satellite, but is publicly known. This allows the GPS receiver to discriminate or detect the individual signal of each of the satellites in the presence of signals from the other satellites and in the presence of noise.

Each satellite transmits at least one other signal, employing the same carrier frequency that is shifted 90 degrees. This second signal is modulated by another code, known as the P(Y) code. The P(Y) code is either the P, which is publicly known, or the encrypted Y code. Today, all satellites use the Y code and, consequently, the resulting transmitted signal that is encoded with the Y code cannot be used by anyone other than those who have the decryption algorithm and the key.

Each satellite transmits yet another signal, at frequency L2. Although the present invention is described mainly with reference to frequency L1, it should be understood that the principles disclosed herein apply to L1, L2, or any of the new frequencies that are planned for satellite navigation.

The present invention is described by way of examples based on the pervasive GPS system. Nonetheless, it should be understood that the principles disclosed herein apply to other global positioning or navigation systems. That is, the applicability of the present invention extends beyond the GPS system. The following section briefly describes GPS signals and processing of the signals in a conventional GPS receiver. Terms referring to global positioning (without initial letters being capitalized) refer to the terms generically, and not necessarily solely to GPS. Deficiencies in the GPS system as described herein are found in all other non-encrypted systems.

A conventional GPS receiver, shown in FIG. 1, simultaneously receives a number of satellite signals on frequency L1, where the signal transmitted by satellite n can be expressed as

S_{transmitted}=AⁿDⁿ(t)x_{C/A}ⁿ(t)cos(2π(f_{L1})t+φ₁)+BⁿDⁿ(t)x_{Y}ⁿ(t)sin(2π(f_{L1})t+φ₁) (1)

where Dⁿ(t) is the data signal, x_{C/A}ⁿ(t) is the C/A code signal assigned to satellite n, f_{L1} is the frequency of the carrier, and φ₁ is the phase of the carrier relative to the beginning of the data and code signals.

A GPS receiver can engage in the processing of signals as if all of the possible satellites are present. However, some of the satellites are not within view of the GPS receiver's antenna and, as such, the processing results for those satellites are not viable. The following analysis follows the signal of only one satellite and, for sake of simplicity, superscript n is omitted from the equations, and the C/A subscript is shortened to C.

The transmitted signal is subjected to transit time delay to the receiver, τ, and the signal that is received by a receiver's antenna experiences a Doppler frequency shift, f_{D}, due to the satellite's movement in its orbit and possible receiver motion. Also, the transmitter and the receiver do not have a common clock, which means that even when the transmitter and the receiver clocks are at identical frequency, there is, nevertheless, a phase difference between them. Thus, the received signal thus can be expressed as

S_{received}=AD(t−τ)x_{C}(t−τ)cos(2π(f_{L1}+f_{D})(t−τ)+φ₁)+BD(t−τ)x_{Y}(t−τ)sin(2π(f_{L1}+f_{D})(t−τ)+φ₁) (2)

or simplified to

S_{received}=AD(t−τ)x_{C}(t−τ)cos(2π(f_{L1}+f_{D})t+φ₁−φ₂)+BD(t−τ)x_{Y}(t−τ)sin(2π(f_{L1}+f_{D})t)+φ₁−φ₂) (3)

As shown in FIG. 1, the received signal is amplified in element 10 which may include a band pass filter and low noise amplifier. The amplified signal is then conventionally downshifted to a preselected intermediate frequency (IF) by multiplying the received signal in element 12 by signal

sin(2π(f_{L1}−f_{IF})t+φ₃) (4)

and passing the resulting signal through low pass filter 15. The signal of equation (4) is generated from reference oscillator 20 by frequency synthesizer 22, where φ₃ is the phase of the locally generated signal (relative to the beginning of the data and code signals at the transmitting satellite which, of course, is unknown). The result at the output of the low pass filter is

S_{downshifted}=AD(t−τ)x_{C}(t−τ)cos(2π(f_{IF}+f_{D})t+φ₁−φ₂−φ₃)+BD(t−τ)x_{Y}(t−τ)sin(2π(f_{IF}+f_{D})t+φ₁−φ₂−φ₃) (5)

or simplified to

S_{downshifted}=AD(t−τ)x_{C}(t−τ)cos(2π(f_{IF}+f_{D})t+θ₁)+BD(t−τ)x_{Y}(t−τ)sin(2π(f_{IF}+f_{D})t+θ₁). (6)

The output signal of low pass filter 15 is digitized in A/D converter 18 and applied to a combination of processor 100 and associated memory 110 where the remainder of the processing takes place.

The above-described use of downshifting by use of an IF modulator 12 and low pass filter 15 is exemplary. The A/D 18 can be connected directly to amplifier 10 and controlled to generate a digital signal as if it were downshifted as shown in FIG. 1.

Processing in the processor 100 begins at a signal acquisition (software) module that includes a code generation element and a carrier generation element. The code generation element develops signal

x_{C}(t−\hat{τ}), (7)

where \hat{τ} is an estimate of τ, and the carrier generation element creates two signals that may be viewed as the phasor

Ψ=cos(2π(f_{IF}+\hat{f}_{D})t+\hat{θ}₁)−i sin(2π(f_{IF}+\hat{f}_{D})t+\hat{θ}₁), (8)

where \hat{f}_{D} is an estimate of the Doppler frequency shift f_{D}, and \hat{θ}₁ is an estimate of the phase θ₁. Multiplying the received (and downshifted) signal of equation (6) by the code signal of equation (7) and the phasor of equation (8) and then integrating the product over a preselected interval that is long enough to reliably detect a correlation peak (for example, more than one or more periods of the C/A code) yields:

∫F_{C}Ψ cos(2π(f_{IF}+f_{D})t+θ₁)]+∫F_{Y}Ψ sin(2π(f_{IF}+f_{D})t+θ₁)] (9)

where

F_{C}=AD(t−τ)x_{C}(t−τ)x_{C}(t−\hat{τ}) and F_{Y}=BD(t−τ)x_{Y}(t−τ)x_{C}(t−\hat{τ}) (10)

Equation (9) expands to

$$\begin{matrix}{S}_{I} {S}_{Q} = \int {F}_{C} \{ \begin{matrix}\begin{matrix}cos ( 2 π ( {f}_{IF} + {\hat{f}}_{D} ) t + {\hat{θ}}_{1} ) \\ cos ( 2 π ( {f}_{IF} + {\hat{f}}_{D} ) t + {\hat{θ}}_{1} ) -\end{matrix} \\ \begin{matrix}isin ( 2 π ( {f}_{IF} + {\hat{f}}_{D} ) t + {\hat{θ}}_{1} ) \\ cos ( 2 π ( {f}_{IF} + {\hat{f}}_{D} ) t + {\hat{θ}}_{1} )\end{matrix}\end{matrix} \} + \int {F}_{Y} \{ \begin{matrix}\begin{matrix}cos ( 2 π ( {f}_{IF} + {\hat{f}}_{D} ) t + {\hat{θ}}_{1} ) \\ sin ( 2 π ( {f}_{IF} + {f}_{D} ) t + {\hat{θ}}_{1} ) -\end{matrix} \\ \begin{matrix}isin ( 2 π ( {f}_{IF} + {\hat{f}}_{D} ) t + {\hat{θ}}_{1} ) \\ sin ( 2 π ( {f}_{IF} + {f}_{D} ) t + {\hat{θ}}_{1} )\end{matrix}\end{matrix} \} & ( 11 ) \\ or to & \\ {S}_{I} {S}_{Q} = \int {F}_{C} \{ \begin{matrix}\begin{matrix}cos ( 2 π ( 2 {f}_{IF} + {f}_{D} + {\hat{f}}_{D} ) t + {θ}_{1} + {\hat{θ}}_{1} ) + \\ cos ( 2 π ( {f}_{D} + {\hat{f}}_{D} ) t + {θ}_{1} - {\hat{θ}}_{1} ) -\end{matrix} \\ \begin{matrix}isin ( 2 π ( 2 {f}_{IF} + {f}_{D} + {\hat{f}}_{D} ) t + {θ}_{1} + {\hat{θ}}_{1} ) + \\ isin ( 2 π ( {f}_{D} + {\hat{f}}_{D} ) t + {θ}_{1} - {\hat{θ}}_{1} )\end{matrix}\end{matrix} \} + \int {F}_{Y} \{ \begin{matrix}\begin{matrix}sin ( 2 π ( 2 {f}_{IF} + {f}_{D} + {\hat{f}}_{D} ) t + {θ}_{1} + {\hat{θ}}_{1} ) + \\ sin ( 2 π ( {f}_{D} + {\hat{f}}_{D} ) t + {θ}_{1} - {\hat{θ}}_{1} ) -\end{matrix} \\ \begin{matrix}icos ( 2 π ( 2 {f}_{IF} + {f}_{D} + {\hat{f}}_{D} ) t + {θ}_{1} + {\hat{θ}}_{1} ) + \\ icos ( 2 π ( {f}_{D} + {\hat{f}}_{D} ) t + {θ}_{1} - {\hat{θ}}_{1} )\end{matrix}\end{matrix} \} . & ( 12 )\end{matrix}$$

Since, as indicated above,

F_{Y}=BD(t−τ)x_{Y}(t−τ)x_{C}(t−\hat{τ}), (13)

and the C/A code is orthogonal to the Y code, the second integral of equation (12) yields zero. Also, the integration acts like a low pass filter that discards the high frequency signals of cos(2π(2f_{IF}+f_{D}+\hat{f}_{D})t and sin(2π(2f_{IF}+f_{D}+\hat{f}_{D})t, leaving

$${S}_{I} {S}_{Q} = \int {F}_{C} \{ \begin{matrix}+ cos ( 2 π ( {f}_{D} + {\hat{f}}_{D} ) t + {θ}_{1} - {\hat{θ}}_{1} ) + \\ isin ( 2 π ( {f}_{D} + {\hat{f}}_{D} ) t + {θ}_{1} - {\hat{θ}}_{1} )\end{matrix} \} . \qquad ( 14 )$$

It can be demonstrated that S_{I}²+S_{Q}² equals

$$\begin{matrix}{S}_{I}^{2} {S}_{Q}^{2} = {( \int {F}_{C} cos ( 2 π ( {f}_{D} + {\hat{f}}_{D} ) t + {θ}_{1} - {\hat{θ}}_{1} ) )}^{2} + \\ {( \int {F}_{C} sin ( 2 π ( {f}_{D} + {\hat{f}}_{D} ) t + {θ}_{1} - {\hat{θ}}_{1} ) )}^{2} \\ = {( \int {F}_{c} cos 2 π ( {f}_{D} + {\hat{f}}_{D} ) t )}^{2} + {( \int {F}_{c} sin 2 π ( {f}_{D} + {\hat{f}}_{D} ) t )}^{2}\end{matrix} \qquad ( 15 )$$

which is independent of (θ₁−\hat{θ}₁). It can be also demonstrated that good estimates for τ, and f_{D} are attained when the code generation module is adjusted as to introduce a delay, \hat{τ}, and the carrier generator module is adjusted as to the introduced \hat{f}_{D} so as to maximize S_{I}²+S_{Q}².

FIG. 2 shows a diagrammatic representation of the processing that takes place in the acquisition module of processor 100. The processing includes processing at the carrier generation element and the code generation element.

The main task of the acquisition module is to generate a first-cut approximation of the delay and the Doppler frequency shift. A refinement of the approximations takes place in a tracking module, whose function is both to refine the estimates and to track the changes in τ, f_{D} and θ₁ as conditions change, and whose diagrammatic representation is shown in FIG. 3.

The tracking module contains a phase lock loop comprising multiplier 31 that multiplies the S_{downshifted} signal of equation (6) by the phasor of equation (8) provided by numerically controlled oscillator (carrier NCO) 32. The output of multiplier 31 is multiplied in multiplier 33 by the code signal obtained from code generator 38. The output of multiplier 33 is integrated in module 34 and applied to discriminator 35, which develops a carrier error signal (θ₁−\hat{θ}₁) that controls the frequency of the carrier NCO.

The output of multiplier 31 is also applied to multiplier 36, where it is multiplied by the code signal that is generated by element 38, but delayed by half of the duration of code C/A chip; i.e.,

x_{C}(t−\hat{τ}−T_{C}/2), (16)

and to multiplier 37, where it is multiplied by the code signal that is generated by element 38, but advanced by half of the duration of code C/A chip; i.e.,

x_{C}(t−\hat{τ}+T_{C}/2). (17)

The outputs of multipliers 36 and 37 are integrated in elements 41 and 42, respectively, and applied to discriminator 39 which develops a delay error signal (τ−\hat{τ}) that is applied to code generator 38, controlling the frequency of the clock that generates the code.

While in both elements 32 and 38 the frequency of a clock is controlled by the respective discriminators, the result is that the generated carrier frequency phasor that is applied to multiplier 31 is in the form

cos(2π(f_{IF}+\hat{f}_{D})t+\hat{θ}₁)−i sin(2π(f_{IF}+\hat{f}_{D})t+\hat{θ}₁) (18)

with the approximations \hat{f}_{D} and \hat{θ}₁ tracking closely the f_{D} and θ₁ of equation (6), and the generated code

x_{C}(t−\hat{τ}) (19)

has a \hat{τ} that is a close estimate of τ.

The code and the carrier measurement are applied to subsequent modules (not shown) that decode the navigation message, determine satellite ephemeris, and compute the pseudo-range, and with corresponding pseudo-ranges obtained by processing other satellites, the physical location of the receiver is computed (through quadralateration) and displayed.

All of the above is conventional and described in “Global Positioning System” by Misra and Enge, Ganga-Jamuna Press, 2006, which is incorporated herein by reference. Alternate implementation to the above may be used for GPS processing. In one example, the code and carrier removal processes described by equations (7), (8) and (9) may be performed in a different order. In another example, correlator spacings may be chosen differently from those chosen in equations (16) and (17). As yet another example, discriminator strategies may differ from the simple “early minus late” strategy described above.

In commercial applications the C/A code is publicly known and, consequently, GPS receivers are vulnerable to spoofing. A hostile party can generate a facsimile of one or more satellite signals that carry incorrect information. A GPS receiver that accepts the bogus signals will compute an incorrect position and, in fact, may be caused to compute a position that the hostile party wishes to have the receiver compute. However, spoofing is not a problem for those using the Y code because this code is not publicly known. As such, a hostile party cannot create a signal that appears bona fide. This spoofing problem is not unique to GPS receivers, and is endemic to all global positioning systems that rely on insecure signals.

### SUMMARY

The primary object of the present invention is to create methods and systems for gaining confidence that a global position computation, or an assertion based on a global position, is bona fide. More specifically, exemplary embodiments of the present invention authenticate an assertion relative to an integrated circuit (IC), regarding that IC's location at one or more times, e.g., the IC's location at the time of manufacture.

The above and other objects are achieved by storing in the IC to be authenticated at least one signal segment from which global position of the IC can be determined. In an exemplary embodiment, this at least one signal segment is stored in the IC at the time and place of manufacture. The signal segment is derived from a signal from which global position can be computed, and which includes a number of components that are not known and, therefore, cannot be cloned, as well as possibly a number of components that are known. In an exemplary embodiment, the signal is a signal from the GPS system. In another exemplary embodiment, the signal is a signal from Global Navigation Satellite Systems (GNSS). The signal may also be a signal from terrestrial sources, satellites in low earth orbit, satellites in geosynchronous orbit, etc. For convenience, the following disclosure uses the GPS signal to represent whatever signal is used from which global position can be computed.

In addition to storing the aforementioned at least one signal segment, an assertion is stored in the device regarding the IC's global position when the signal segment was received, as well as an encryption key. The stored key is the publicly available key of an authentication authority's public-private key pair. The stored information is placed in a memory of the IC that is accessible only in a very controlled manner. Lastly, the device is imbued with processing capability.

To authenticate the IC, in accord with one exemplary embodiment the device encrypts the stored assertion using the stored key and sends the resultant string to the authentication authority. The authentication authority decrypts the received string, retrieves the assertion regarding global position and time that pertain to the stored signal segment, and sends a challenge signal to the IC. The IC processes the challenge signal with the aid of the stored signal segments, and sends the result, encrypted with the stored encryption key, back to the authentication authority. The authentication authority processes the received encrypted result and determines whether the IC's assertion is bona fide.

In accord with another exemplary embodiment, the IC sends both the assertion and the signal segment, encrypted with the stored public key, to the authentication authority. The authentication authority decrypts the received information and authenticates the assertion based on the received signal segment.

### BRIEF DESCRIPTION OF THE DRAWINGS

FIG. 1 is a block diagram of an exemplary conventional GPS receiver;

FIG. 2 is a block diagram of exemplary processing performed in an acquisition module of a GPS receiver;

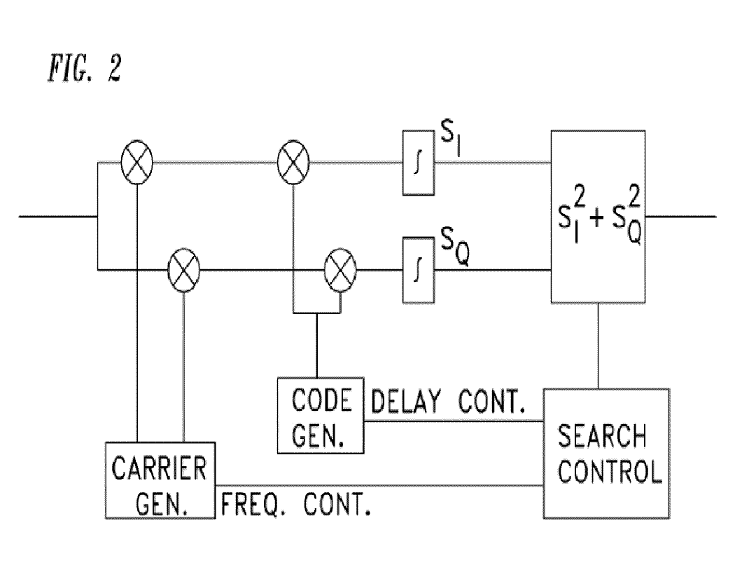

FIG. 3 is a block diagram of exemplary processing performed in a tracking module of a GPS receiver;

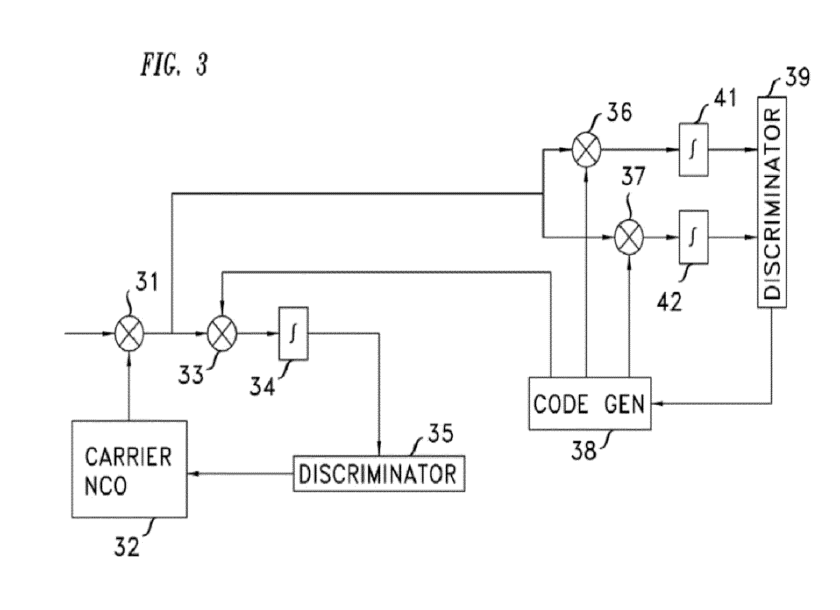

FIG. 4 depicts an exemplary arrangement including an exemplary IC and exemplary GPS receiving units communicating over an exemplary communication network;

FIG. 5 illustrates exemplary processing within the authenticating GPS receiver when the first receiver obtains good estimates of transit delay, Doppler frequency shift and carrier phase shift, and provides a signal to the authenticating GPS receiver with carrier wipeoff already carried out;

FIG. 6 illustrates exemplary processing within the authenticating GPS receiver when the first receiver obtains good estimates of transit delay, Doppler frequency shift and carrier phase shift, and provides to the authenticating GPS receiver a raw signal that contains information about all satellites whose signals are received by the first GPS receiver, and the transit delay, Doppler frequency shift and carrier phase shift estimates of all of those satellites;

FIG. 7 illustrates exemplary processing within the authenticating GPS receiver when the signal that the first GPS receiver sends is the raw signal only;

FIG. 8 illustrates an exemplary method for authenticating an IC by use of stored GPS signals;

FIG. 9A illustrates part of the exemplary method of FIG. 8 as performed at the IC to be authenticated;

FIG. 9B illustrates part of the exemplary method of FIG. 8 as performed at the authentication authority;

FIG. 10 illustrates another exemplary method for authenticating an IC by use of stored GPS signals;

FIG. 11A illustrates part of the exemplary method of FIG. 10 as performed at the IC to be authenticated; and

FIG. 11B illustrates part of the exemplary method of FIG. 10 as performed at the authentication authority.

### DETAILED DESCRIPTION

An important realization that is disclosed herein is that given a signal from a source that comprises a secure, though unknown, component and a corresponding known but not secure component, where both the known and unknown components are similarly affected by physical conditions and those effects are computed for the known component, it is possible to authenticate the known component by using a second signal that is a changed version of the signal from the source—where either the second signal or the given signal is known to be bona fide—through use of the unknown components of the given signal and of the second signal.

The following applies this insight to the problem where the source is one or more satellites that output signals which are used for various purposes, including global positioning; and more particularly to the aforementioned problem in the context of the Global Positioning System. It should be understood, however, that the principles disclosed herein are not limited to the illustrative embodiment presented below.

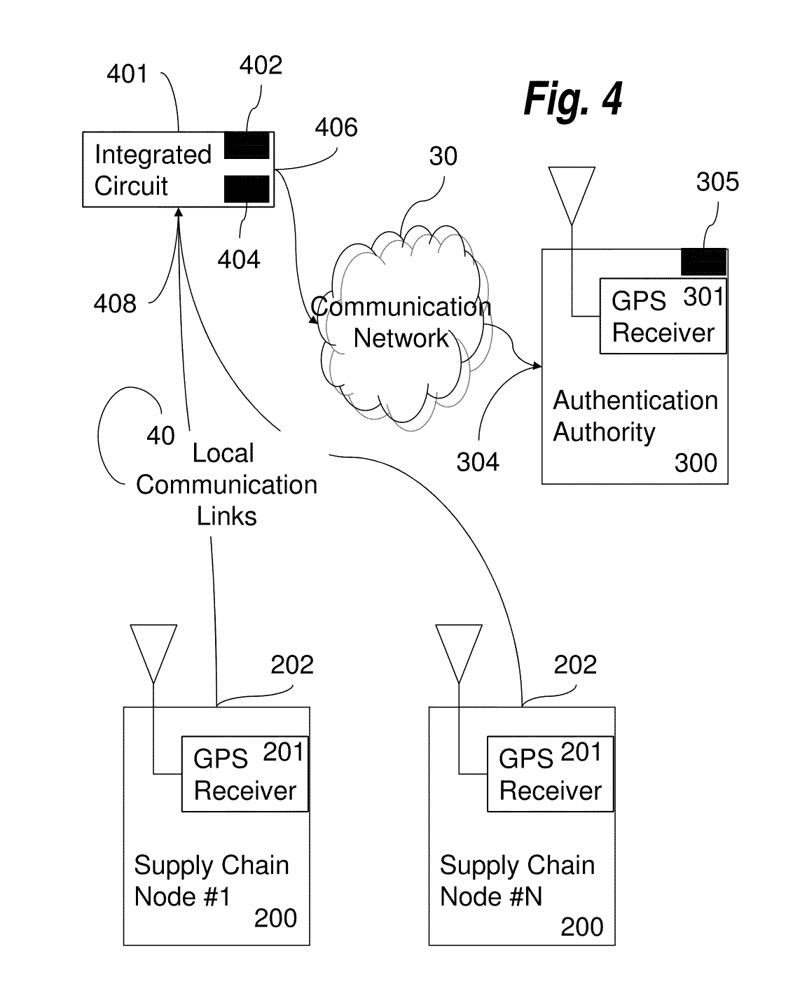

FIG. 4 represents one illustrative embodiment of the invention disclosed herein. A integrated circuit (IC) 401 includes a processor 402 capable of processing any of the methods disclosed herein. For example, the processor 402 may process GPS signals, generate digitized signatures from the GPS signals, compare different digitized signatures, and determine a location from the comparison. The IC 401 also includes memory 404 which may be protected, embedded memory for storing digitized signatures derived from GPS signals, asserted locations and times, authentication keys, etc. The IC 401 further includes a communication port 406 which may be used to transmit signals to and receive signals from an authentication authority 300 over a communication network 30. The IC 401 also includes a communication port 408 which may be used to transmit signals to and receive signals from supply chain nodes 200 over local communication links 40.

The IC may be associated with and in proximity to one or more supply chain nodes 200 at different points in the supply chain which connects the IC manufacturing plant to the end user of the IC, e.g., fabrication, test, packaging, integration, burn-in, first field use, etc. Each supply chain node 200 includes a GPS receiver 201 for receiving and processing GPS signals, and a communication port 202 for transmitting signals to and receiving signals from the IC 401 over the local communication links 40.

The authentication authority 300 includes a GPS receiver 301 for receiving and processing GPS signals, and a communication port 304 for transmitting signals to and receiving signals from the IC 401 over the communication network 30. The authentication authority 300 also includes a processor 305 capable of processing any of the methods disclosed herein. For example, the processor 305 may process GPS signals, generate digitized signatures from the GPS signals, compare different digitized signatures, and determine a location from the comparison.

The GPS receivers 201 and 301 are modified in accord with the principles disclosed herein. For the illustrative example of FIG. 4, it is presumed that receiver 301 receives bona fide satellite signals.

For purposes of the global location authentication that is described below, the local communication links 40 and the communication network 30 do not need to be secure. It is expected, however, that in some applications these links will need to be secure, e.g., where the communication link is also used to send back authorizations.

Unit 201 receives the signals from a number of satellites and processes them as described above to compute the global position of unit 201 based on the received signals. In the course of processing the signal of satellite n, the signal of equation (12) is developed, and as part of developing this signal unit 201 creates a signal that corresponds to the received (and downshifted) signal of equation (6) multiplied by the phasor of equation (8). That is, unit 201 creates the signal (downshifted, carrier wipeoff relative to satellite n, but not C/A code wipeoff):

$$\begin{matrix}{A}^{A} {D}^{A} ( t - {τ}^{A} ) {x}_{C}^{A} ( t - {\hat{τ}}^{A} ) \{ \begin{matrix}cos ( \begin{matrix}2 π ( 2 {f}_{IF} + {f}_{D}^{A} + {\hat{f}}_{D}^{A} ) t + \\ {θ}_{1}^{A} + {\hat{θ}}_{1}^{A}\end{matrix} ) + \\ cos ( 2 π ( {f}_{D}^{A} - {\hat{f}}_{D}^{A} ) t + {θ}_{1}^{A} + {\hat{θ}}_{1}^{A} ) - \\ isin ( \begin{matrix}2 π ( 2 {f}_{IF} + {f}_{D}^{A} + {\hat{f}}_{D}^{A} ) t + \\ {θ}_{1}^{A} + {\hat{θ}}_{1}^{A}\end{matrix} ) + \\ isin ( 2 π ( {f}_{D}^{A} - {\hat{f}}_{D}^{A} ) t + {θ}_{1}^{A} + {\hat{θ}}_{1}^{A} )\end{matrix} \} + & ( 20 ) \\ {B}^{A} {D}^{A} ( t - {τ}^{A} ) {x}_{Y}^{A} ( t - {\hat{τ}}^{A} ) \{ \begin{matrix}sin ( \begin{matrix}2 π ( 2 {f}_{IF} + {f}_{D}^{A} + {\hat{f}}_{D}^{A} ) t + \\ {θ}_{1}^{A} + {\hat{θ}}_{1}^{A}\end{matrix} ) + \\ sin ( 2 π ( {f}_{D}^{A} - {\hat{f}}_{D}^{A} ) t + {θ}_{1}^{A} + {\hat{θ}}_{1}^{A} ) + \\ icos ( \begin{matrix}2 π ( 2 {f}_{IF} + {f}_{D}^{A} + {\hat{f}}_{D}^{A} ) t + \\ {θ}_{1}^{A} + {\hat{θ}}_{1}^{A}\end{matrix} ) - \\ icos ( 2 π ( {f}_{D}^{A} - {\hat{f}}_{D}^{A} ) t + {θ}_{1}^{A} + {\hat{θ}}_{1}^{A} )\end{matrix} \} . & \end{matrix}$$

where the superscript A designates the signal of unit 201.

A low pass filter discards the terms with frequency on the order of 2πf_{IF}, leaving

$$\begin{matrix}{A}^{A} {D}^{A} ( t - {τ}^{A} ) {x}_{C}^{A} ( t - {\hat{τ}}^{A} ) \{ \begin{matrix}cos ( 2 π ( {f}_{D}^{A} - {\hat{f}}_{D}^{A} ) t + {θ}_{1}^{A} + {\hat{θ}}_{1}^{A} ) + \\ isin ( 2 π ( {f}_{D}^{A} - {\hat{f}}_{D}^{A} ) t + {θ}_{1}^{A} + {\hat{θ}}_{1}^{A} )\end{matrix} \} + & ( 21 ) \\ {B}^{A} {D}^{A} ( t - {τ}^{A} ) {x}_{Y}^{A} ( t - {\hat{τ}}^{A} ) \{ \begin{matrix}sin ( 2 π ( {f}_{D}^{A} - {\hat{f}}_{D}^{A} ) t + {θ}_{1}^{A} + {\hat{θ}}_{1}^{A} ) - \\ icos ( 2 π ( {f}_{D}^{A} - {\hat{f}}_{D}^{A} ) t + {θ}_{1}^{A} + {\hat{θ}}_{1}^{A} )\end{matrix} \} & \end{matrix}$$

which can be written as

S_{I}^{A}+iS_{Q}^{A} (22)

where

S_{I}^{A}=A^{A}D^{A}(t−τ^{A})x_{C}^{A}(t−\hat{τ}^{A})cos(2π(f_{D}^{A}−\hat{f}_{D}^{A})t+θ₁^{A}−\hat{θ}₁^{A})+B^{A}D^{A}(t−τ^{A})x_{Y}^{A}(t−\hat{τ}^{A})sin(2π(f_{D}^{A}−\hat{f}_{D}^{A})t+θ₁^{A}−\hat{θ}₁^{A}) (23)

and

S_{Q}^{A}=A^{A}D^{A}(t−τ^{A})x_{C}^{A}(t−\hat{t}^{A})sin(2π(f_{D}^{A}−\hat{f}_{D}^{A})t+θ₁^{A}−\hat{θ}₁^{A})−B^{A}D^{A}(t−τ^{A})x_{Y}^{A}(t−\hat{t}^{A})cos(2π(f_{D}^{A}−\hat{f}_{D}^{A})t+θ₁^{A}−\hat{θ}₁^{A}). (24)

### Exemplary Approach A

In accordance with a first exemplary approach, unit 201 sends the quadrature signal of equation (24) to unit 401 over link 40, together with identification of the satellite whose signal the sent signal represents.

Unit 301 develops a similar signal; that is,

S_{Q}^{B}=A^{B}D^{B}(t−τ^{B})x_{C}^{B}(t−\hat{τ}^{B})sin(2π(f_{D}^{B}−\hat{f}_{D}^{B})t+θ₁^{B}−\hat{θ}₁^{B})−B^{B}D^{B}(t−τ^{B})x_{Y}^{B}(t−\hat{τ}^{B})cos(2π(f_{D}^{B}−\hat{f}_{D}^{B})t+θ₁^{B}−\hat{θ}₁^{B}). (25)

Units 201 and 301 receive similar GPS signals near simultaneously. However, the transit time from a satellite to unit 201, τ^{A}, is different from the transit time from the same satellite to unit 301, τ^{B}, so in accord with the first approach, the signal received from unit 201 is delayed by δ, where δ may be a positive or negative quantity, and a product of the signals S_{Q}^{A} (delayed) and S_{Q}^{B} is integrated; i.e.,

$$\begin{matrix}S = \int [ {S}_{Q}^{A} ( delayed ) \times {S}_{Q}^{B} ] \\ = \int [ \begin{matrix}\{ \begin{matrix}{A}^{A} {D}^{A} ( t - {τ}^{A} - δ ) {x}_{C}^{A} ( t - {\hat{τ}}^{A} - δ ) \\ sin ( 2 π ( {f}_{D}^{A} - {\hat{f}}_{D}^{A} ) ( t - δ ) + {θ}_{1}^{A} + {\hat{θ}}_{1}^{A} ) - \\ {B}^{A} {D}^{A} ( t - {τ}^{A} - δ ) {x}_{Y}^{A} ( t - {\hat{τ}}^{A} - δ ) \\ cos ( 2 π ( {f}_{D}^{A} - {\hat{f}}_{D}^{A} ) t + {θ}_{1}^{A} + {\hat{θ}}_{1}^{A} )\end{matrix} \} \times \\ \{ \begin{matrix}{A}^{B} {D}^{B} ( t - {τ}^{B} ) {x}_{C}^{B} ( t - {\hat{τ}}^{B} ) \\ sin ( 2 π ( {f}_{D}^{A} - {\hat{f}}_{D}^{A} ) t + {θ}_{1}^{B} + {\hat{θ}}_{1}^{B} ) - \\ \begin{matrix}{B}^{B} {D}^{B} ( t - {τ}^{B} ) {x}_{Y}^{B} ( t - {\hat{τ}}^{B} ) \\ cos ( 2 π ( {f}_{D}^{B} - {\hat{f}}_{D}^{B} ) t + {θ}_{1}^{B} + {\hat{θ}}_{1}^{B} )\end{matrix}\end{matrix} \}\end{matrix} ]\end{matrix} \qquad ( 26 )$$

which can be written in more manageable form as

S=∫[XU−YU−XW+YW] (27)

where

X=A^{A}D^{A}(t−τ^{A}−δ)x_{C}^{A}(t−\hat{τ}^{A}−δ)sin(2π(f_{D}^{A}−\hat{f}_{D}^{A})t+θ₁^{A}−\hat{θ}₁^{A}) (28)

Y=B^{A}D^{A}(t−τ^{A}−δ)x_{Y}^{A}(t−\hat{τ}^{A}−δ)cos(2π(f_{D}^{A}−\hat{f}_{D}^{A})t+θ₁^{A}−\hat{θ}₁^{A}) (29)

U=A^{B}D^{B}(t−τ^{B})x_{C}^{B}(t−τ^{B})sin(2π(f_{D}^{B}−\hat{f}_{D}^{B})t+θ₁^{B}−\hat{θ}₁^{B}) (30)

and

W=B^{B}D^{B}(t−τ^{B})x_{Y}^{B}(t−\hat{τ}^{B})cos(2π(f_{D}^{B}−\hat{f}_{D}^{B})t+θ₁^{B}−\hat{θ}₁^{B}). (31)

As indicated above, the estimates of \hat{τ}^{A}, \hat{f}_{D}^{A}, and \hat{θ}₁^{A}, are quite good, and so are the estimates of \hat{τ}^{B}, \hat{f}_{D}^{B}, and \hat{θ}₁^{B}. Given accurate information about the phase shifts, unit 301 can perform coherent demodulation. Consequently, over the integration interval that needs to be employed for equation (26), the sin( )terms can be replaced with 0 (i.e., X=U=0), and the cos( )terms can be replaced with their respective coefficients. This leads to

S=B^{A}B^{B}∫D^{A}(t−τ^{A}−δ)D^{B}(t−τ^{B})x_{Y}^{A}(t−τ^{A}−δ)x_{Y}^{B}(t−τ^{B}). (32)

Clearly, when the signal of unit 301 is bona fide and, therefore,

x_{Y}^{B}(t−τ^{B}) is equal to x_{Y}^{A}(t−τ^{B}),

D^{A}(t−τ^{B}) is equal to D^{B}(t−τ^{B}), and

(D^{B}(t−τ^{B}))²=1, because the message signal, D, can only have ±1 values.

Thus, the value of S in equation (32) is maximum when δ=τ^{B}−τ^{A}; i.e.,

S=B^{A}B^{B}. (33)

In this way, without knowing the Y code signal x_{Y}(t−τ), the arrangement of FIG. 4 executes a method that recognizes—by the value of S for different values of δ—when a signal that is received by unit 201 and a signal that is received by unit 301 originate from a given source that outputs a signal that is modulated with a signal x_{Y}(t−τ), when that is the case; and conversely, recognizes when one of the signals is not from the given source. Specifically, a sharp peak in the value of S at some value of δ indicates the likelihood that the signal provided by unit 200 is bona fide and that δ is the time delay between the arrival of the satellite's signal to unit 200 and the arrival of the satellite's signal to unit 300. Computing this value of δ for a number of different satellites permits evaluation of the global position of unit 200 relative to the global position of unit 300 in a conventional manner.

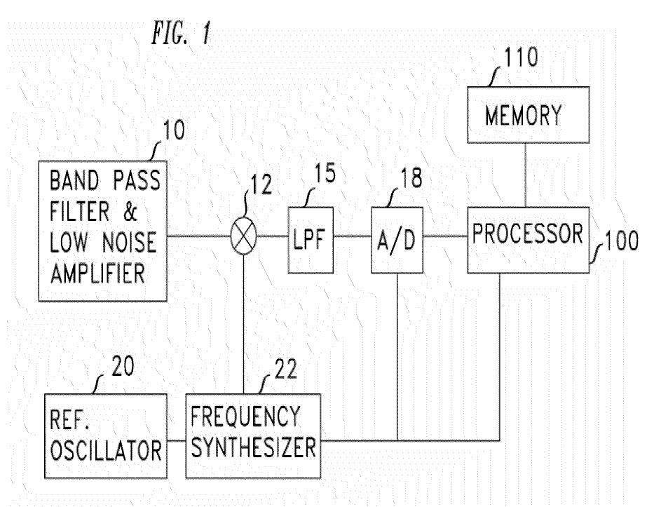

One can appreciate that the receiver shown in FIG. 1 includes processor 100 and memory 110 that operate on digital signals and, therefore, can be implemented in a programmed general purpose processor. Similarly, unit 201 can include hardware elements that correspond to elements 10, 12, 15, 18, 20 and 22, and employ the computing power of portable computer 200 to carry out the various calculations disclosed above, which in the FIG. 1 embodiment would be performed in element 100 and its associated memory 110. The software that is necessary in unit 201 to augment the conventional receiver advantageously implements a filter to develop the signal of equation (24) from the signal of equation (20), and a module for sending to line 30 the signal of equation (24), and the identity of the satellite whose signal is represented by the sent signal. This extremely modest addition to the software is quite simple, which a skilled artisan can create without undue experimentation in any one of a number of techniques that are well known in the art.

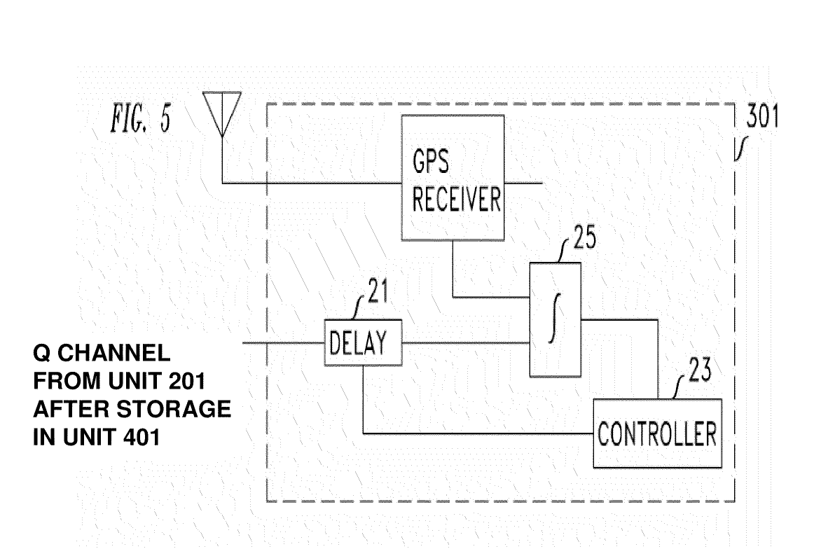

The modification to the GPS receiver in unit 301 is somewhat greater than in unit 201, but still quite simple to implement in a programmed general purpose processor. FIG. 5 diagrammatically shows unit 301 to include a port to receive the signal originally received by unit 201, a delay unit 21 that is responsive to the equation (25) signal, and a correlation module 25 that is responsive to the delayed signal at the output of delay unit 21 and to the signal of equation (25) that is extracted from the signals that the conventional GPS receiver creates in the course of determining its global position.

The correlation unit computes the integral of equation (26) with function S=function A(δ), and provides the developed value S to controller module 23. The correlation function provides an indication of the degree to which signal A, with some delay, is the same as signal B. When they are indeed the same, then the correlation outputs a high value, or a peak. Bogus signals, even when they are somewhat similar to the authentic signal, will result in lower correlation value regardless of what delay is chosen. One simple way, therefore, is to compare the strongest correlation peak to the next strongest peak. This is illustrated by the following function that module 23 executes:

for δ (−N, +N, ΔN)
do

Call S = function A(δ)
If S > S_{highWaterMark} then {

S_{nextHighest} = S_{highWaterMark}
S_{highWaterMark} = S }

Done
if (S_{highWaterMark}/S_{nextHighest}) > Threshold then output “OK”
else output “NOT OK”
end if

where N is greater than the expected delay difference (τ^{B}−τ^{A}), and ΔN is the increment that a designer might choose to employ in seeking the maximum in the correlation function of equation (26). Of course, if unit 201 were to send the value of \hat{τ}^{B} along with the signal of equation (24) then the range of N can be reduced significantly because it would be expected to find a maximum at δ=0.

It should be noted that the above is just one embodiment of the test that is performed on the correlation results. It may be noted, for example, that in embodiments that employ high sampling rates several large peaks may appear, but those peak are artifacts, and in such embodiments other tests are typically employed that factor in the sampling rate (as related to ΔN) and the relative position of the peaks, to determine which points to compare for the threshold.

It is recognized that in order to compute a global position, the signal of more than one satellite must be used. Therefore, authenticating the signal of one satellite, as disclosed above, does not, ipso facto, guarantee authenticity of the integrated circuit that carries the signal originally received by one of the units 201. However, the concatenation of the above described tests for multiple satellites at each of multiple realizations of unit 201 along the IC supply chain can be sent to unit 301 for authentication. If all of the signals are authenticated or a substantial fraction of these signals are authenticated, then one can trust that the integrated circuit is authentic.

It should also be noted that the location can be computed using more than the minimum number of satellites (4 satellites to compute latitude, longitude, elevation and GPS time). Having a majority of the signals authenticated can be used to test the consistency of non-authenticated signals, provided that the location estimate reported by unit 201 agrees with the location estimate developed using a subset of authenticated satellites.

Once confidence is gained about the signals provided by unit 201 that are used to compute a global position of unit 201 then one can also have confidence in an identification of the integrated circuit. This assumes, of course, that the units 201 compute their global position (in a completely conventional way) and this data is also conveyed to unit 301 by unit 401 and the associated data links.

Alternatively, instead of trusting unit 201's assertion of its position, it is possible to have unit 301 compute the position of unit 201. This secure position determination is achieved by unit 201 sending the equation (24) signals of a number of satellites that is necessary to compute a position. Noting that the δ determined relative to a satellite informs of the transit delay from the satellite to unit 201 (τ^{B}=τ^{A}+δ), given a sufficient number of transit delays (combined with unit 301's global position and information about the satellites' locations) the global position of unit 201 can be ascertained through conventional calculations.

It may be appreciated that authenticating an asserted position, or securely determining a position, does not need to be done continually. At times the global position of units 201 or 401 is immaterial. Therefore, in many applications it is acceptable if unit 401 sends only a signal segment, or snapshot, to unit 301.

It should also be appreciated that unit 401 contains a memory for storing one or more signal segments (raw, or processed), and the stored information may be communicated to unit 301 at some later time (i.e., a non-real time operation). The transfer of information from unit 401 may be initiated by an electronic instruction from unit 301, by physically transferring the memory from unit 401 to an appropriate connector on unit 301, or by some other communication means.

In a first embodiment, shown in FIG. 5, unit 201 sends to unit 401 the signal of equation (24), which is the signal after carrier wipeoff relative to satellite n, and this signal is subsequently sent to unit 301.

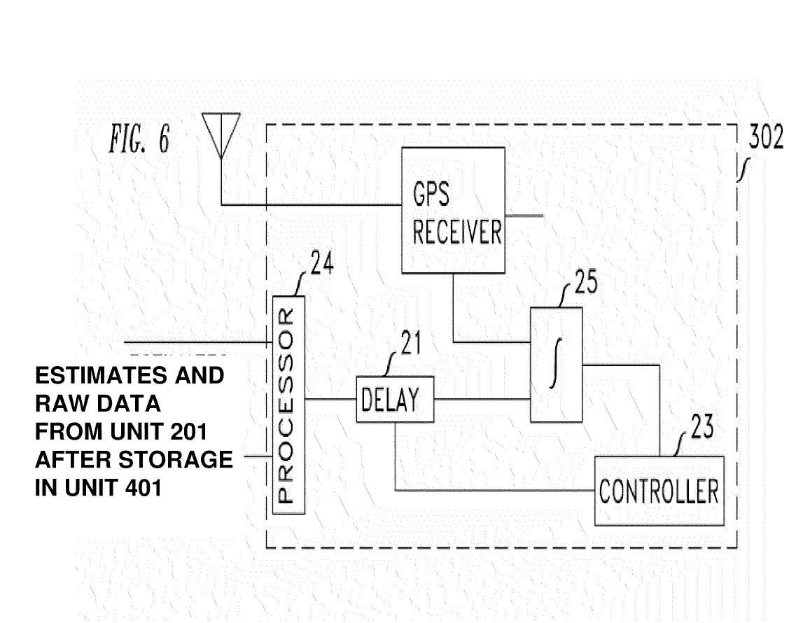

In an alternative embodiment, shown in FIG. 6, rather than sending quadrature channel signal as described above, unit 201 sends to unit 401 the raw data and also sends the computed Doppler frequency and carrier phase estimates for at least each of the satellites that is used in computing its global position. The difference between unit 301 and 302 is that in unit 302 the raw data and the estimates are processed in processor 24 to develop the quadrature channel signal of equation (24).

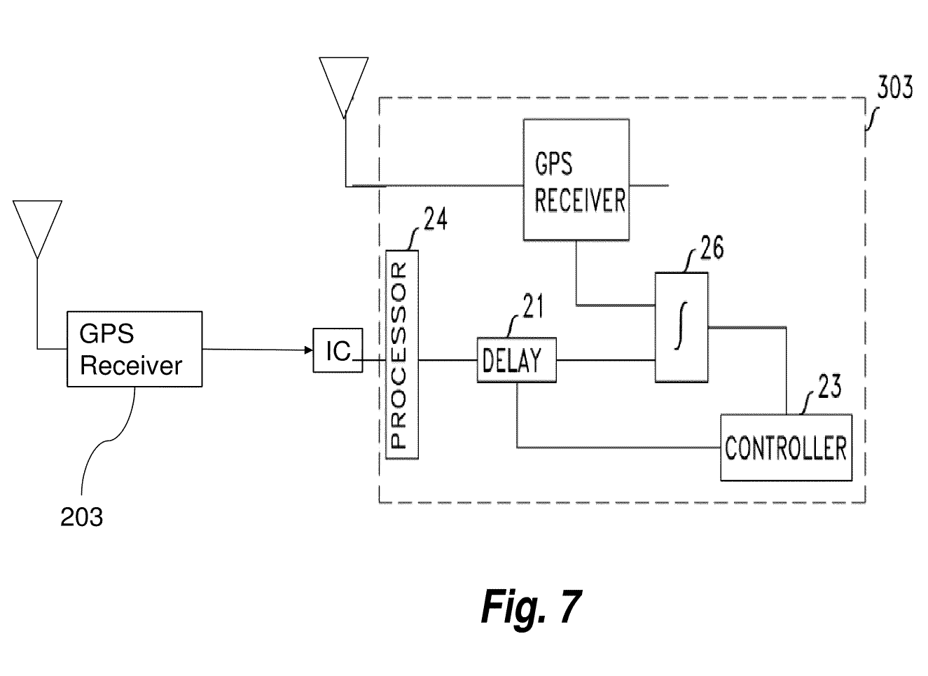

In the IC applications considered here, it may be totally unimportant for unit 401 to know its location but, rather, it may suffice for the other receiver (e.g., unit 301 in FIG. 4) to know where unit 401 is, or has been. In other words, there are applications where it may not be necessary for the GPS receiver do the processing that is associated with determining its global position. To that end, unit 203 (FIG. 7) needs to merely record raw signal segments within unit 401 for future delivery to unit 303.

### Exemplary Approach B

FIG. 7 depicts an arrangement with the GPS receiver 203 that is optionally devoid of the processing that involves carrier wipeoff and code wipeoff. The receiver, 203, only downshifts the received signal and stores this raw data within unit 401 that sends this raw data to receiver 303 (without any delay, Doppler shift, or phase estimates), together, perhaps with some general information about its presumed (or asserted) location and the time of the signal segment. In short, the raw data are stored in the memory of unit 401 and sent at a later time to unit 303. The signal that is provided to receiver 303 is:

S_{downshifted}^{A}=A^{A}D^{A}(t−τ^{A})x_{C}^{A}(t−τ^{A})cos(2π(f_{IF}+f_{D}^{A})t+θ₁^{A})+BD(t−τ^{A})x_{Y}^{A}(t−τ^{A})sin(2π(f_{IF}+f_{D}^{A})t+θ₁^{A}) (34)

and rough location and time information which, from satellite orbit tables that are publicly known, an estimate \hat{f}_{D}^{A} is obtained. The rough information may be in the form of an assertion as to the location of receiver 203. It is recognized that no information is available about the value of θ^{A}, and that the estimate \hat{f}_{D}^{A} is likely to be inaccurate but it is nevertheless helpful, as is demonstrated below. Absent information about θ^{A}, processor 24 executes non-coherent demodulation and multiplies the incoming signal by

cos 2π(f_{IF}+\hat{f}_{D}^{A})t+i sin 2π(f_{IF}+\hat{f}_{D}^{A})t (35)

to result in

$$\begin{matrix}{A}^{A} {D}^{A} ( t - {τ}^{A} ) {x}_{C}^{A} ( t - {τ}^{A} ) \{ \begin{matrix}cos ( \begin{matrix}2 π ( 2 {f}_{IF} + {f}_{D}^{A} + {\hat{f}}_{D}^{A} ) t + \\ {θ}_{1}^{A}\end{matrix} ) + \\ cos ( 2 π ( {f}_{D}^{A} - {\hat{f}}_{D}^{A} ) t + {θ}_{1}^{A} ) - \\ isin ( \begin{matrix}2 π ( 2 {f}_{IF} + {f}_{D}^{A} + {\hat{f}}_{D}^{A} ) t + \\ {θ}_{1}^{A}\end{matrix} ) + \\ isin ( 2 π ( {f}_{D}^{A} - {\hat{f}}_{D}^{A} ) t + {θ}_{1}^{A} )\end{matrix} \} + \\ {B}^{A} {D}^{A} ( t - {τ}^{A} ) {x}_{Y}^{A} ( t - {τ}^{A} ) \{ \begin{matrix}sin ( \begin{matrix}2 π ( 2 {f}_{IF} + {f}_{D}^{A} + {\hat{f}}_{D}^{A} ) t + \\ {θ}_{1}^{A}\end{matrix} ) + \\ sin ( 2 π ( {f}_{D}^{A} - {\hat{f}}_{D}^{A} ) t + {θ}_{1}^{A} ) + \\ icos ( \begin{matrix}2 π ( 2 {f}_{IF} + {f}_{D}^{A} + {\hat{f}}_{D}^{A} ) t + \\ {θ}_{1}^{A}\end{matrix} ) - \\ icos ( 2 π ( {f}_{D}^{A} - {\hat{f}}_{D}^{A} ) t + {θ}_{1}^{A} )\end{matrix} \}\end{matrix} \qquad ( 36 )$$

and recognizing that a later integration operation operates as a low pass filter that discards the signal components that include the 2f_{IF} frequency, equation (34) can be simplified to

S_{I}^{A}+S_{Q}^{A}=(W+X)+i(Y−Z) (37)

where

W=A^{A}D^{A}(t−τ^{A})x_{C}^{A}(t−τ^{A})cos(2π(f_{D}^{A}−\hat{f}_{D}^{A})t+θ₁^{A}) (38)

X=B^{A}D^{A}(t−τ^{A})x_{Y}^{A}(t−τ^{A})sin(2π(f_{D}^{A}−\hat{f}_{D}^{A})t+θ₁^{A}) (39)

Y=A^{A}D^{A}(t−τ^{A})x_{C}^{A}(t−τ^{A})sin(2π(f_{D}^{A}−\hat{f}_{D}^{A})t+θ₁^{A}) (40)

and

Z=B^{A}D^{A}(t−τ^{A})x_{Y}^{A}(t−τ^{A})cos(2π(f_{D}^{A}−\hat{f}_{D}^{A})t+θ₁^{A}). (41)

Delay element 21 of FIG. 7 introduces delay δ, and element 26 in the FIG. 7 embodiment executes the integration

$$S = \sqrt{{( {\int }_{I}^{A} ( delayed ) \times {S}_{Q}^{B} )}^{2} + {( {\int }_{Q}^{A} ( delayed ) \times {S}_{Q}^{B} )}^{2}} . \qquad ( 42 )$$

Noting that equation (25) specifies S_{Q}^{B}, which can be expressed by

S_{Q}^{B}=U+V

where

U=A^{B}D^{B}(t−τ^{B})x_{C}^{B}(t−\hat{τ}^{B})sin(2π(f_{D}^{B}−\hat{f}_{D}^{B})t+θ₁^{B}−\hat{θ}₁^{B}) (43)

and

V=−B^{B}D^{B}(t−τ^{B})x_{Y}^{B}(t−\hat{τ}^{B})cos(2π(f_{D}^{B}−\hat{f}_{D}^{B})t+θ₁^{B}−\hat{θ}₁^{B}), (44)

equation (42) can be expressed as

$$S = \sqrt{\begin{matrix}{( \int ( {W}^{′} U + {W}^{′} V + {X}^{′} U + {X}^{′} V ) )}^{2} + \\ {( \int ( {Y}^{′} U + {Y}^{′} V + {Z}^{′} U + {Z}^{′} V ) )}^{2}\end{matrix}} \qquad ( 45 )$$

where the primed variables (e.g., W′) are the delayed version of the unprimed variables (e.g., W).

A number of observations and approximations can be made that reduce the complexity of equation (45).
Since the approximations of the Doppler frequency and carrier phase shift for unit 303 signal are good, the sin( )term in the U term can be replaced by 0, and the cos( )term in the V term can be replaced by 1.
The W and the Y terms have the x_{C}^{A}(t−τ^{A}) code signal multiplier whereas the V term has the x_{Y}^{B}(t−\hat{τ}^{B}) code signal multiplier, and since the two codes are orthogonal to each other, the contributions of the WV and the YV terms to the integral is roughly 0.
As indicated above, the estimate \hat{f}_{D}^{A} is not necessarily an accurate estimate, but even it if a rough estimate, the resulting trigonometric function varies slowly relative to the chip rate of the Y code, which allows the non-trigonometric factors that are common to XV and ZV to be factored out, and then the sum of squared sin( ) and cos( ) terms that remain can be replaced by 1.

The above allows reducing equation (45) to

S=B^{A}B^{B}∫D^{A}(t−τ^{A}−δ)D^{B}(t−τ^{B})x_{Y}^{A}(t−τ^{A}−δ)x_{Y}^{B}(t−\hat{τ}^{B}), (46)

so it is quite clear that the integration result exhibits a maximum when τ^{A}δ=\hat{τ}^{B} and the code x_{Y}^{A}(t)=x_{Y}^{B}(t).

As before, controller 23 finds the delay δ that provides the peak value of S, and compares it to other values in order to determine whether the signal originally received by unit 203 contains a bona fide signal from that particular satellite for which the processing operation of equation (46) was just executed.

Needless to say, Approaches A and B, described above, are simply two preferred implementations and many variations exist. For example, unit 201 could send C/A code information as well as Y code information. In this case, unit 301 could determine the relative timing, δ=τ^{B}−τ^{A}, for the C/A code as well as the Y code and insist that they agree. Other variations exist. Under Approach A, unit 201 performs code and carrier wipeoff and unit 301 coherently demodulates the data. Under Approach B, unit 201 does not perform code or carrier wipeoff. Rather, it sends, more primitive, downshifted data, and unit 301 performs non-coherent demodulation. This pairing is mutable. In other words, unit 201 could send downshifted data and unit 301 could perform coherent demodulation.

The software with which one might wish to implement a particular embodiment of the invention disclosed herein is fairly simple to implement; though, of course, it takes time to create, as all software does. Notwithstanding the fact that the software needed to implement the invention disclosed herein is totally straight forward and can be easily implemented without undue experimentation by any person skilled in the art, to assist the reader, an appendix is included herein of an actual embodiment.

The above illustrative embodiment has the first set of receivers along the supply chain for integrated circuits and a remote authenticating receiver. It should be mentioned explicitly that the assumption is that the signal received by receiver 301 is not impacted by a bogus signal to which the supply chain receivers may be subjected. A mere physical separation, when it is big enough so that the receivers are not subjected to the signal of a given (bogus) source, tends to prevent this situation because a hostile party is not likely to be able to send a bogus signal to units 201 and to also send an appropriate replica of the same bogus signal to receiver 301. Additionally, receiver 301 can take steps to ensure that this does not happen by, for example, using antennas that are electronically directed to respond well to signals only from certain directions (where the satellites are expected to be) and to not respond well to signals from other directions.

One advantage of the FIG. 4 embodiment is that it efficiently supports many supplicant-resource pairs because it requires no GPS receiving or sophisticated processing by the integrated circuit, and because the authentication authority can afford to make greater efforts to ensure that its signal B is authentic. The authentication authority can afford to employ expensive antenna arrangements and other techniques to verify the bona fide nature of signal B because the cost may be amortized over many customers of the authentication authority.

In addition to (or in lieu of) using very directional antennas, the authentication authority can be located at some physically remote location that is secure from transmission by hostile parties. The remoteness makes it more likely than not that a hostile party will not succeed in transmitting to the directional antennas, and it will almost certainly ensure that whatever hostile signal is transmitted to units 201 will not correspond to the hostile signals to which the authentication authority might be subjected.

Further, the authentication authority can be located permanently at its secure location and can make the effort to know its own global position with great accuracy. This allows the authentication authority to compute its location from the received signals and by comparing the computed location with the known location it can confirm that its received signals are bona fide. Moreover, since the authentication of a location is effectively decided by comparing an asserted location to a location computed relative to the location of the authentication authority, an accurate location of the authentication authority is important.

Further still, the authentication authority can itself receive other signals that it can process to confirm the bona fide nature of its signal B—for example, from locations that are greatly removed from the authentication authority location that receives signal B, or from other systems (e.g., LORAN).

In yet another improvement, the authentication authority has a number of facilities, at different locations around the globe, and the signal B that is used for processing is from a location that is selected truly randomly (in contrast to pseudorandomly) from among the different locations.

As described above, this invention is directed at the authentication of integrated circuits. Advances in analysis of extant (physical) semiconductor devices, as well as the relative ease with which unlicensed designs can be captured, copied, and replicated have created a multi-billion dollar black-market for pirated chips, not unlike the markets that already exist for commodity items such as clothes and fashion accessories. It has been estimated that 4.5% of memory and integrated circuits installed within host systems are counterfeit, or of unlicensed provenance. Therefore, sometimes, it is not so much that one desires to know where the asset has been, as much as one desires to know that the asset has not been tampered with, or substituted for with a bogus asset. This, in effect, is a somewhat different application that may best be characterized as “Integrated Circuit Authentication.”

As suggested by the above, the “IC authentication” application is implemented by storing in the IC to be authenticated (or tracked) at least the signal time segment related to the GPS signal that is received at the time and place of manufacture of the asset. It is important, of course, to have the stored signal time segments be secure from alterations, and that can be accomplished by permanently storing those signals in an unalterable memory within the asset, or in a memory that cannot be accessed except an by embedded module that itself cannot be altered. Illustratively, this module is a processor, which may be a stored program controlled processor where the stored program resides in a read-only memory within the asset.

The following describes an embodiment where one wishes to verify the place and time of manufacture of an integrated circuit (IC), as a means of ensuring that a counterfeit IC is not being used. In other words, only one signal time sample is stored in the IC, and that is the signal that corresponds to the GPS signal that is received at the place and time of manufacture of the IC. Accordingly, the IC contains a memory, and a processor for performing computations that involve accessing the memory. In order to ensure that no bogus signals are inserted into the IC, no other means are provided in the IC for accessing the memory, and if the processor is a stored-program processor, the software that controls the processor—and through which the memory can be accessed—is unalterable. Advantageously, the stored program is not even accessible, except to initiate the authentication process. This makes the memory and its contents secure, and the processing performed in the IC secure. To distinguish the above-mentioned memory and processor from other memories and/or processors that the IC may have, the discussion below refers to this memory as memory-x and to this processor as mPx.

### First Exemplary Embodiment

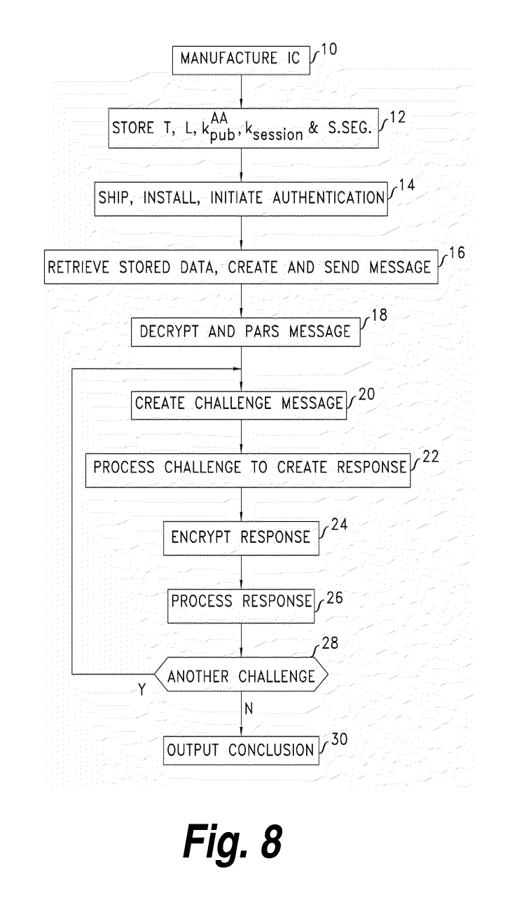

FIG. 8 presents a block diagram of the process in this first embodiment.

In step 10 the IC is manufactured. It is presumed that the IC is manufactured by Manufacturer (M), that the location of manufacture has a GPS receiver, and that the location of that GPS is known by an authentication authority (AA) with certainty. How the AA knows the location of M's GPS receiver with certainty is not a part of this invention. A simple approach that may be used is for the AA to send a trusted person to a location identified by M, and to have that person confirm that the identified location is, indeed, within a manufacturing facility of M.

AA also has a GPS receiver at its premises, and it records, processes, and stores the received GPS signals for purposes of authentication. The signals that are stored are ones that correspond to equation (34). Alternatively, it is the signals that correspond to equation (24). It is assumed that the AA is secure.

Prior to (or concurrently with) manufacturing step 10 party M obtains a key, k_{Pub}^{AA}, of AA, which is the public key of a pair of keys belonging to AA. AA has the other key, k_{Pri}^{AA}, which is the private key of the public key pair. The keys k_{Pub}^{AA} and k_{Pri}^{AA} are different, and k_{Pri}^{AA}(k_{Pri}^{AA}(S))=S, where S is any string. See public key encryption teachings in the art if more information is desired, such as how to create a public key pair.

How M obtains k_{Pub}^{AA}, and is assured that the obtained key truly corresponds to the pair of keys belonging to AA, is also not a part of this invention. Use of a trusted authority to certify the public key of AA is one approach.

It may be noted that the process of obtaining k_{Pub}^{AA} is carried out only once, unless AA changes its public key pair from time to time (such as for each batch of ICs that manufacturer M is authorized to produce).

Returning to step 10, as M manufactures an IC it reaches a stage where data may be placed in memory-x. At this point control passes to step 12 where information is stored in memory-x of the IC; to wit:
AA's public key, k_{Pub}^{AA};
The assertion tuple T:L, where T is the date and time of when the data is inserted into memory-x, and L is the global position of M's GPS receiver (i.e., the global position that is known to AA); and
A signal time segment (S.Seg) of a preselected duration derived from the signals received by the GPS receiver. The signal time segment may be considered part of a digitized signature derived from GPS signals received at a local site associated with the IC. In one exemplary embodiment, this signal time segment corresponds to the signal specified in equation (34). In another exemplary embodiment, the signal time segment comprises the set of signals as specified in equation (24), each corresponding to a different satellite.
   Optionally, step 12 also creates and stores an encryption key (which may be a symmetric key, but does not have to be) that constitutes a session key for authenticating the IC.

Control then passes to step 14 where the manufactured IC is shipped to a customer, for example a system assembler. The IC is incorporated by the system assembler into a system, communication between the IC and AA is established, and mPx is caused to initiate the authentication process. The initiation is caused by a command that the system assembler supplies to mPx or that AA supplies.

Control then transfers to step 16, where mPx retrieves the assertion tuple T:L, retrieves the AA's public key, creates the string k_{Pub}^{AA}(T:L) and sends it to AA. If a session key is stored in memory-x then the created string is k_{Pub}^{AA}(T:L:kₛₑₛₛᵢₒₙ).

In step 18, AA receives the encrypted message and decrypts it using k_{Pri}^{AA}; i.e., AA computes k_{Pri}^{AA}(k_{Pub}^{AA}(T:L))=T:L, or k_{Pri}^{AA}(k_{Pub}^{AA}(T:L:kₛₑₛₛᵢₒₙ))=T:L:kₛₑₛₛᵢₒₙ.

In step 20, the AA creates a challenge signal or message and sends it to the IC at the system assembler's location. An exemplary challenge may be a signal time segment corresponding to time T, which is retrieved by mPx from its storage, a signal time segment corresponding to a time that is offset from T by some chosen amount, some other signal time segment that is not chosen to be related to T, or noise (a segment of random or pseudorandom numbers). The challenge message may be considered part of a digitized signature derived from GPS signals received at a remote location associated with the AA. When the AA receives a session key from the IC, it encrypts the challenge with the session key and sends the resulting string to the IC. Otherwise, it sends the challenge to the IC in the clear.

Control then passes to step 22, where mPx in the IC processes the challenge signal (first decrypted by use of the session key, if it exists) in accordance with the above teachings. Illustratively, step 22 identifies a set of delays that correspond to a peak in the correlation relative to each satellite signal (i.e., the delay δ is described above in connection with the process executed by module 23). Control then passes to step 24 which sends the set of delays—which is the result developed in response to the received challenge—to AA. In some applications (e.g., when only one challenge is sent and that challenge is the signal time segment corresponding to time T) it is advisable to obfuscate the response message that is to be sent to AA.

The obfuscation may take the form of appending an additional string to the message, for example, a nonce, and encrypting the resulting string with either the public key of AA or with the session key (if one exists). Optionally, the values of the correlation peaks are included in the response message, and those correlation peaks provide the desired obfuscation.

When the challenge that was sent is a signal time segment that corresponds to time T, the set of delay values is used to identify a location associated with the IC. In an exemplary embodiment, the location may be a global position. In another exemplary embodiment, the location may be a location associated with the IC relative to the AA. In yet another exemplary embodiment, the location may be a location associated with the AA relative to the IC.

When the identified global position associated with the IC corresponds to the (accepted as bona fide) location of Manufacturer's manufacturing facility then step 26 concludes that the IC is bona fide. When the challenge that was sent is a signal time segment that corresponds to a time slightly different from T, then the set of delays identifies a different global position that is close to Manufacturer's manufacturing facility. When the challenge that was sent is a signal time segment that corresponds to a time that is not chosen to be related to T, or when the segment is random, then the identified location is not expected to be at or near Manufacturer's manufacturing facility and, of course, it is not even necessary for step 26 to compute a global position estimate.

Optionally, to raise security to an even higher level, more than one challenge is presented to the IC. In such an embodiment (which FIG. 8 depicts), control passes from step 26 to step 28, which determines whether to send another challenge. If so, control returns to step 20 with the intent of sending another, different, challenge. The sequence of challenges advantageously employs different signal time segments, where one of the time segments is nominally for time T. When no other challenge is to be sent, control passes to step 30 which determines whether the IC is bona fide or not, based on the set of computations in response to the set of challenges that step 26 performed. The AA then communicates that determination to the system assembler.

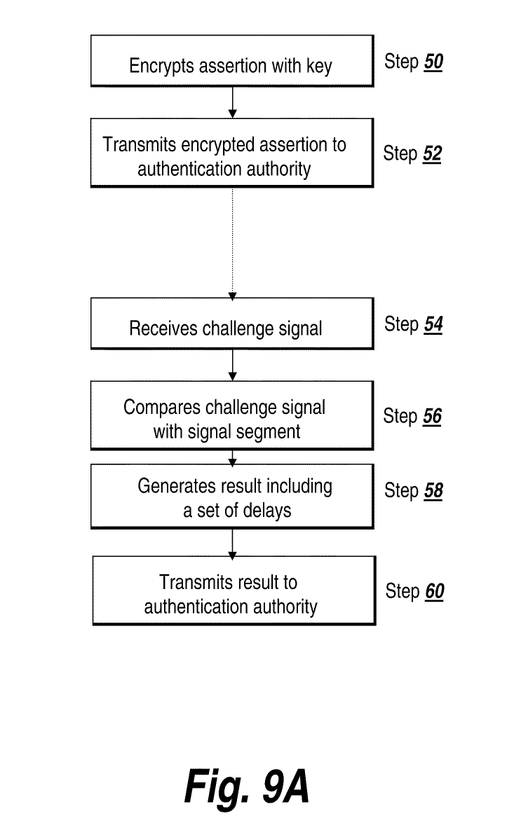

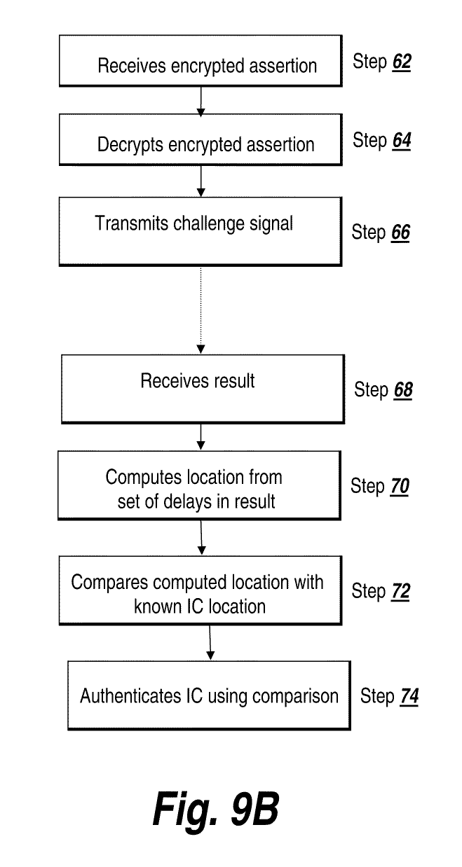

FIG. 9A is a flowchart illustrating part of the method of FIG. 8 as occurring at the IC. FIG. 9B is a flowchart illustrating part of the method of FIG. 8 as occurring at the AA.

At step 50 in FIG. 9A, the IC encrypts its stored assertion with the public key of the AA. At step 52, the IC transmits the encrypted assertion to the authentication authority. At step 62 in FIG. 9B, the AA receives the encrypted assertion from the IC. At step 64, the AA decrypts the encrypted assertion using its private key corresponding to the public key used in the encryption. At step 66, the AA determines, obtains or retrieves a challenge signal, and transmits the challenge signal to the IC.

At step 54 in FIG. 9A, the IC receives the challenge signal from the AA. At step 56, the IC compares the challenge signal with its stored signal segment, e.g. by correlating the challenge signal and the signal segment. In step 58, the correlation generates a result including a set of delays that correspond to a peak in the correlation relative to each satellite signal. In step 60, the IC transmits the result including the set of delays to the AA.

At step 68, the AA receives the result from the IC. At step 70, the AA uses the set of delays in the result to compute the global location corresponding to the set of delays. At step 72, the AA compares the computer global location with the known location of the IC. At step 74, the AA authenticates the IC based on the comparison and the nature of the challenge signal transmitted to the IC.

### Second Exemplary Embodiment

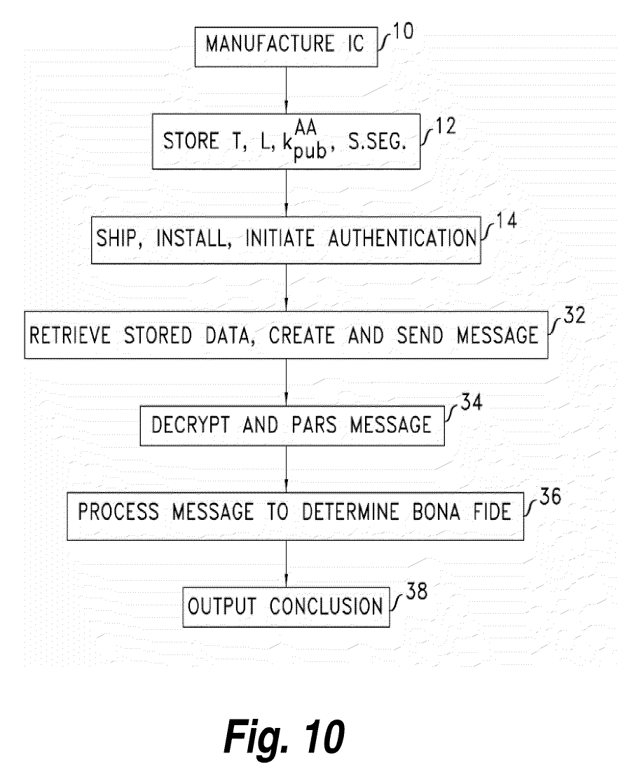

A second embodiment in consonance with the principles disclosed herein is similar to the first embodiment, except that the heart of the processing which is undertaken in order to determine whether the IC is bona fide is carried out in the AA rather than in the IC. This embodiment is illustrated in FIG. 10.

Specifically, steps 10, 12 and 14 are identical to correspondingly numbered steps in FIG. 8, and when step 32 is reached, the mPx within the IC encrypts the string T:L:S.Seg with the public key of AA, and sends the resulting string k_{Pub}^{AA}(T:L:S.Seg) to AA. Control then passes to step 34 where the message that is received by AA is decrypted, and parsed. At this point the AA has the signal time segment that is stored in the IC, the asserted location L, and the asserted time T. In step 36 the AA retrieves from its own storage a signal time segment that corresponds to time T, and processes the retrieved signal time segment and the parsed out signal time segment, as disclosed above, to determine whether a location resulting from the processing of the signal time segments corresponds to the asserted location L. If so, step 38 sends an affirmative message to the system assembler. Otherwise, it sends a negative message to the system assembler.

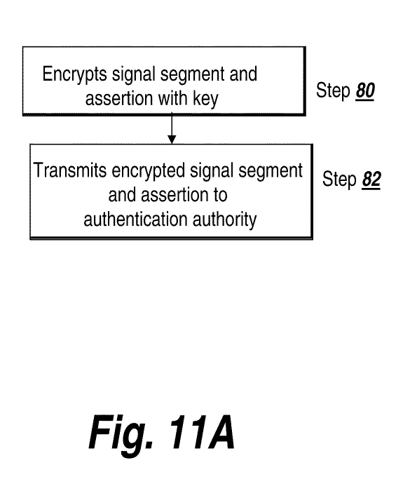

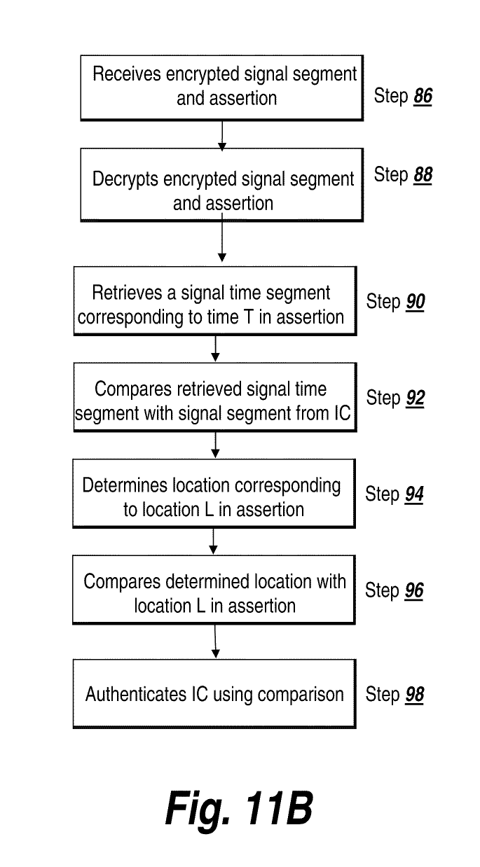

FIG. 11A is a flowchart illustrating part of the method of FIG. 10 as occurring at the IC. FIG. 11B is a flowchart illustrating part of the method of FIG. 10 as occurring at the AA.

In step 80 in FIG. 11A, the IC creates a string containing its stored assertion and stored signal segment, and encrypts the string with the public key of the AA. In step 82, the IC transmits the encrypted string to the AA.

In step 86 in FIG. 11B, the AA receives the encrypted string including the signal segment and the assertion from the IC. In step 88, the AA decrypts and parses the encrypted string to obtain the signal segment, the time T included in the assertion, and the location L included in the assertion. In step 90, the AA retrieves a signal time segment that corresponds to the time T in the assertion. In step 92, the AA compares the retrieved signal time segment with the signal segment in the assertion. In step 94, based on the results of the comparison, the AA determines the global location that corresponds to the location L in the assertion. In step 96, the AA compares the determined location with the actual location L in the assertion. In step 98, the AA authenticates the IC based on the comparison.

1. A method of determining authenticity of an integrated circuit (IC), the method comprising:
receiving a local set of one or more signals at a local site associated with the IC;
receiving a remote set of one or more signals at a remote site, the receiving of the remote set being near simultaneous as the receiving of the local set;
creating a local digitized signature of the first set of signals at the local site;
creating a remote digitized signature of the second of signals at the remote site; and
determining authenticity of the IC based on a comparison of the local signature to the remote signature.

2. The method of claim 1, further comprising:
storing the local signature in a protected, embedded memory on the IC.

3. The method of claim 1, further comprising:
transmitting the local signature to the remote site before the local signature is compared to the remote signature.

4. The method of claim 3, further comprising:
encrypting the local signature before transmitting the local signature to the remote site.

5. The method of claim 1, further comprising:
transmitting the remote signature to the local site before the local signature is compared to the remote signature.

6. The method of claim 5, further comprising:
encrypting the remote signature before transmitting the remote signature to the local site.

7. The method of claim 1, wherein the comparison comprises:
a correlation of the local and remote signatures.

8. The method of claim 1, further comprising:
estimating a location of the local site relative to the remote site, or
estimating a location of the remote site relative to the local site.

9. The method of claim 8, wherein the signals are transmitted by satellites that belong to the Global Navigation Satellite Systems.

10. The method of claim 8, wherein the signals are transmitted by satellites that belong to the Global Positioning System.

11. The method of claim 1, further comprising:
estimating the time at which the signals were transmitted or received.

12. The method of claim 1, wherein the signals are transmitted by one or more satellites in low earth orbit.

13. The method of claim 1, wherein the signals are transmitted by one or more satellites in geosynchronous orbit.

14. The method of claim 1, wherein the signals are transmitted by one or more terrestrial sources.

15. The method of claim 1, wherein the local and remote sets of signals comprise signals received at different points in a supply chain of the IC.

16. The method of claim 1, wherein the determining comprises:
transmitting a challenge signal from the remote site to the local site;
comparing the challenge signal with the local signature at the local site to generate a result; and
authenticating the IC by processing the result at the remote site.

17. The method of claim 16, wherein the comparing comprises:
correlating the challenge signal with the local signature to determine one or more correlation peaks; and
determining one or more delays based on the correlation, each of the one or more delays corresponding to a correlation peak.

18. The method of claim 17, wherein:
the challenge signal is a signature corresponding to an asserted location of the local site, the asserted location being transmitted from the local site to identify a location of the local site; and
the authenticating comprises:
computing a location of the local site based on the one or more delays;
comparing the computed location of the local site with a known, true location of the local site; and
determining that the IC is authentic if the computed location of the local site matches the known, true location of the local site.

19. The method of claim 1, wherein the determining comprises:
transmitting the local signature from the local site to the remote site;
transmitting an asserted location and an asserted time from the local site to the remote site, the asserted location being transmitted from the local site to identify a location of the local site, and the asserted time being transmitted from the local site to identify a time at which the local set of signals was received at the local site;
determining a signature corresponding to the asserted time;
comparing the determined signature with the local signature to generate a result;
using the result to determine a location corresponding to the asserted location; and
authenticating the IC by comparing the determined location with the asserted location.

20. The method of claim 19, wherein:
the comparing comprises correlating the determined signature and the local signature; and
the result of the comparing comprises one or more delays, each of the one or more delays corresponding to a correlation peak.

21. An integrated circuit (IC) system comprising:
a communication port for:
receiving a challenge signal from an authentication system; and
transmitting a result of a comparison involving the challenge signal to the authentication system; and
a processor configured to:
compare the challenge signal with a signal segment derived from a local set of one or more signals received at the IC, the comparison generating the result.

22. The system of claim 21, wherein:
the comparing comprises correlating the challenge signal with the signal segment; and
the result comprises one or more delays, each of the one or more delays corresponding to a correlation peak.

23. The system of claim 21, further comprising:
an authentication system for authenticating the IC, the authentication system comprising:
a communication port for:
transmitting the challenge signal from the authentication system to a local site; and
receiving a result of a signature comparison from the local site; and
a processor configured to:
calculate a location of the local site based on the result of the signature comparison; and
authenticate the IC by comparing the calculated location with a known location of the IC, the IC being authenticated when the calculated location matches the known location of the IC.

24. An authentication system for authenticating an integrated circuit (IC), the authentication system comprising:
a communication port for receiving:
a local signal segment received from a local site, the local signal segment derived from processing a local set of one or more signals received at the local site;
an asserted time received from the local site, the asserted time identifying a time at which the local site received the local set of signals; and
an asserted location received from the local site, the asserted location identifying a location at which the local site received the local set of signals;
a processor configured to:
generate a signal segment of signals corresponding to the asserted time;
compare the generated signal segment with the local signal segment received from the local site to generate a result;
calculate a location of the local site based on the result of comparing the generated signal segment with the local signal segment; and
authenticate the IC by comparing the calculated location of the local site and the asserted location.

25. The authentication system of claim 24, wherein:
the comparing comprises correlating the generated signal segment with the local signal segment; and
the result comprises one or more delays, each of the one or more delays corresponding to a correlation peak.
